(19) United States
(12) Patent Application Publication
(10) Pub. No.: US 2016/0334437 A1
(43) Pub. Date: Nov. 17, 2016

(54) MOBILE TERMINAL, COMPUTER-READABLE RECORDING MEDIUM, AND ACTIVITY RECOGNITION DEVICE

(71) Applicant: FUJITSU LIMITED, Kawasaki-shi (JP)

(72) Inventors: Masafumi Nishida, Shizuoka (JP); Kazuya Takeda, Nagoya (JP); Norihide Kitaoka, Tokushima (JP); Tomoki Hayashi, Nagoya (JP); Yusuke Adachi, Nagoya (JP)

(73) Assignee: FUJITSU LIMITED, Kawasaki-shi (JP)

(21) Appl. No.: 15/133,423

(22) Filed: Apr. 20, 2016

(30) Foreign Application Priority Data
May 13, 2015 (JP) 2015-098556

(51) Int. Cl. G01P 15/00; G01P 13/00; H04M 1/02

(52) U.S. Cl. CPC G01P 15/00; H04M 1/0202; G01P 13/00; H04M 2250/12

(57) ABSTRACT

A mobile terminal measures sensor values in a predetermined period. And the mobile terminal detects whether a missing sensor value exists in the predetermined period. And when the mobile terminal is detected the missing sensor value, the mobile terminal interpolates the missing sensor value with a Gaussian process.

### CROSS-REFERENCE TO RELATED APPLICATION

This application is based upon and claims the benefit of priority of the prior Japanese Patent Application No. 2015-098556, filed on May 13, 2015, the entire contents of which are incorporated herein by reference.

### FIELD

The embodiments discussed herein are related to a mobile terminal, a sensor value interpolation method, a computer-readable recording medium, an activity recognition device, and an activity recognition system.

### BACKGROUND

Mobile terminals such as smartphones equipped with a sensor such as an accelerometer have spread, and services using sensor values are provided. For example, a mobile terminal sequentially collects the acceleration data items with the accelerometer, and the mobile terminal or a cloud server learns the collected acceleration data to perform activity recognition. As described above, the acceleration data items measured by the mobile terminal is used to recognize, for example, the living activities of the user of the mobile terminal.

On the other hand, it is difficult to accurately measure the acceleration data of human motion. This generates a period in which a data item is missing. Furthermore, the frequency of missing data items or the length of period in which a data item is missing varies depending on the conditions. Linear interpolation is used to interpolate such a missing data item. For example, when the acceleration data is collected at a sampling accuracy of 200 Hz and the number of data items is less than 200 samples per second due to a missing data item, the collected data is interpolated with linear interpolation so that the number of samples per second is 200.

Japanese Laid-open Patent Publication No. 2012-108748

In the technique described above, however, the accuracy of interpolation of missing data is not high, and this degrades the accuracy of activity recognition. For example, the data items on both sides of the missing data period are linearly connected in linear interpolation in order to interpolate the missing data. This makes it difficult to accurately reproduce the data that would have been collected in the missing data period. This causes, for example, loss of feature as the contiguous data of acceleration. As a result, activity recognition using the linearly interpolated data may cause false recognition.

### SUMMARY

According to an aspect of the embodiment, a mobile terminal includes a processor that executes a process. The process includes measuring sensor values in a predetermined period; detecting whether a missing sensor value exists in the predetermined period; and interpolating the missing sensor value with a Gaussian process when the missing sensor value exists.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of a functional configuration of a system according to a first embodiment;

FIG. 2 is a diagram of exemplary acceleration data stored in a sensor DB;

FIG. 3 is an explanatory diagram of detection of a missing data period;

FIG. 4 is an explanatory diagram of interpolation of the missing data period;

FIG. 5 is a flowchart of the flow of a learning process;

FIG. 6 is a flowchart of the flow of an interpolation process;

FIG. 7 is an explanatory diagram of exemplary comparison of interpolation;

FIG. 8 is a sequence diagram of the flow of a learning process according to a second embodiment;

FIG. 9 is a sequence diagram of the flow of a learning process according to a third embodiment; and

FIG. 10 is an explanatory diagram of an exemplary hardware configuration.

### DESCRIPTION OF EMBODIMENT(S)

Preferred embodiments of the present invention will be explained with reference to accompanying drawings. Note that the mobile terminal, sensor value interpolation method, computer-readable recording medium, activity recognition device, and activity recognition system are not limited to the embodiments. The embodiments can properly be combined without inconsistencies.

### [a] First Embodiment

### Entire Configuration

An activity recognition system according to the first embodiment includes a mobile terminal 10, and a cloud server 50. The mobile terminal 10 and the cloud server 50 are connected so that the mobile terminal 10 and the cloud server 50 can mutually communicate, for example, via wireless or wired communication. A set of the mobile terminal 10 and the cloud server 50 will be described as an example hereinafter in the embodiments. Note that, however, the numbers of terminals and servers are not limited to the example, and can arbitrarily be changed.

The mobile terminal 10 is an example of a smartphone, a mobile phone, or the like, and includes various sensors including an accelerometer, a gyroscope, a geomagnetic sensor, and a barometer. The mobile terminal 10 transmits a measured sensor value to the cloud server 50. An example in which an accelerometer is used will be described hereinafter in the embodiments.

The cloud server 50 is a computer that performs activity recognition, and an example of a server device or the like. The cloud server 50 receives a sensor value from the mobile terminal 10 and recognizes the activity of the user of the mobile terminal 10 with the received sensor value. For example, the cloud server 50 recognizes the activities, for example, that the user is running, walking, cooking, or cleaning.

In such a system, the mobile terminal 10 measures sensor values in a predetermined period and detects whether a missing sensor value exists in the predetermined period in which the sensor values are measured. When the missing sensor value exists, the mobile terminal 10 interpolates the missing sensor value with a Gaussian process. The cloud server 50 recognizes the activity of the user of the mobile terminal 10 with the sensor values received from the mobile terminal 10 in the predetermined period.

For example, when a missing data period exists in the measured acceleration data, the mobile terminal 10 interpolates the acceleration data in the missing data period with a Gaussian process. This interpolation enables the cloud server 50 to perform the activity recognition with the interpolated acceleration data. As a result, the mobile terminal 10 can improve the accuracy of the activity recognition in the cloud server 50.

Functional Configuration

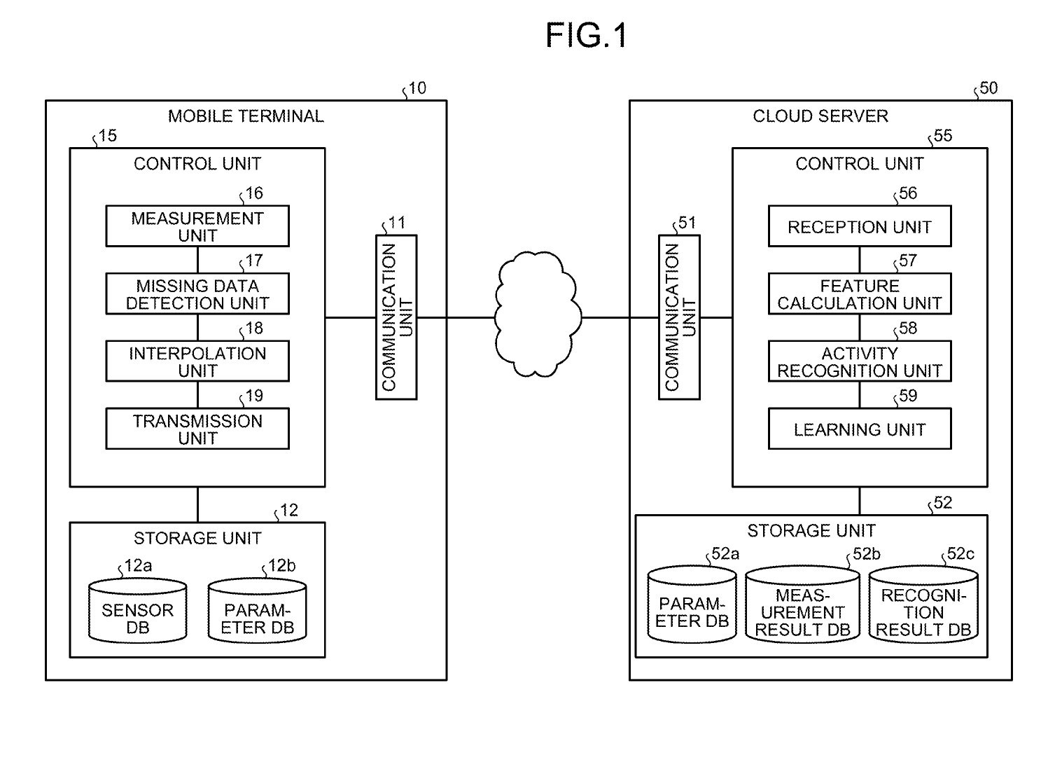

The functional configuration of each component will be described next with reference to FIG. 1. FIG. 1 is a functional block diagram of the functional configuration of the system according to the first embodiment.

Functional Configuration of Mobile Terminal

As illustrated in FIG. 1, the mobile terminal 10 includes a communication unit 11, a storage unit 12, and a control unit 15. The storage unit 12 is an example of a storage device such as a hard disk or a memory. The control unit 15 is an example of a processor such as a Central Processing Unit (CPU) or a Digital Signal Processor (DSP).

The communication unit 11 is a processing unit that performs communication with another device. For example, the communication unit 11 transmits the acceleration data measured by the accelerometer to the cloud server 50. The communication unit 11 receives various types of information including a parameter to be used for interpolation of the acceleration data or an activity recognition result from the cloud server 50.

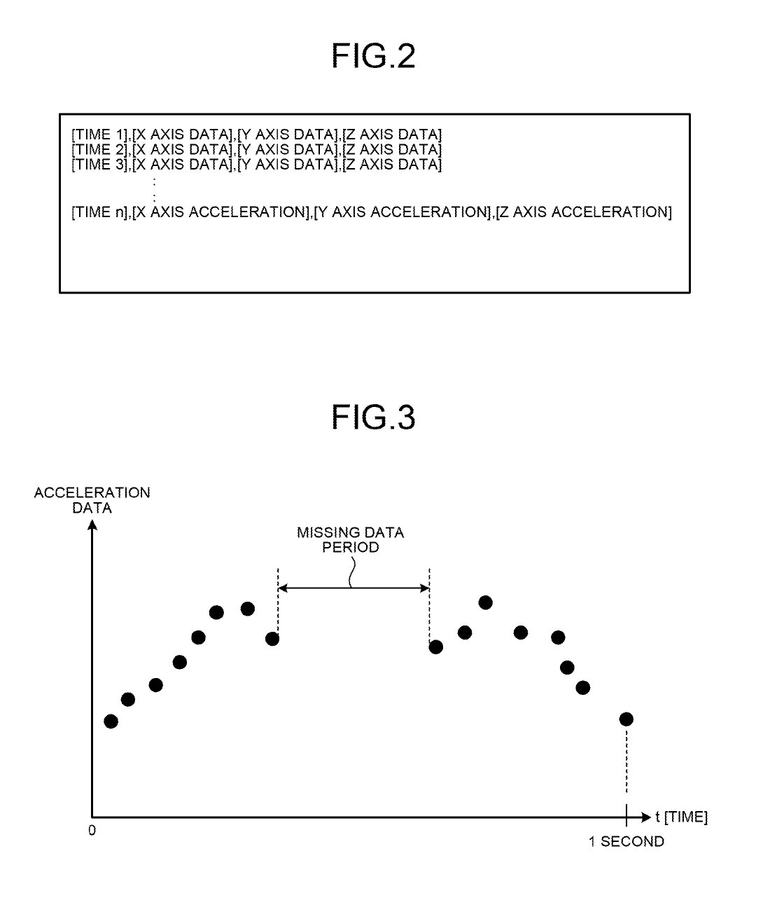

The storage unit 12 is an example of a storage device, and stores a sensor DB 12a and a parameter DB 12b. The sensor DB 12a is a database that stores the acceleration data measured by the accelerometer. FIG. 2 is a diagram of exemplary acceleration data stored in the sensor DB 12a. As described in FIG. 2, the sensor DB 12a stores “a time n, an X axis acceleration, a Y axis acceleration, and a Z axis acceleration” while linking the time and accelerations to each other. The time n is a time when an acceleration data item is measured. The X axis acceleration is the acceleration data item in an X axis direction at the measuring time, the Y axis acceleration is the acceleration data item in a Y axis direction at the measuring time, and the Z axis acceleration is the acceleration data in a Z axis direction at the measuring time. In the example illustrated in FIG. 2, the acceleration data of the X axis data item, Y axis data item, and Z axis data item is measured at a time 1.

The parameter DB 12b is a database that stores a parameter to be used for an interpolation process. For example, the parameter DB 12b stores an average (μ) of the acceleration data items and a variance (σ²) of the acceleration data items as the parameters that can express the Gaussian distribution. In addition to the parameters, the parameter DB 12b can store also, for example, a hyper-parameter of a kernel function and a parameter of a log-likelihood function, which are learnt when the average (μ) and the variance (σ²) are learnt. Note that the exemplified parameters are received from the cloud server 50.

The control unit 15 is a processing unit that controls the entire mobile terminal 10, and includes a measurement unit 16, a missing data detection unit 17, an interpolation unit 18, and a transmission unit 19. Note that the measurement unit 16, the missing data detection unit 17, the interpolation unit 18, and the transmission unit 19 are examples of an electronic circuit in a processor, a process that the processor performs, or the like.

The measurement unit 16 is a processing unit that measures the acceleration data in a predetermined period by using an accelerometer (not illustrated). Specifically, the measurement unit 16 collects, as needed, the acceleration data measured by the accelerometer, and stores the collected data in the sensor DB 12a. Note that the accelerometer measures the acceleration data in an X axis direction, the acceleration data in a Y axis direction, and the acceleration data in a Z axis direction.

The missing data detection unit 17 is a processing unit that detects whether a missing data item exists in the acceleration data measured by the measurement unit 16 in the predetermined period. Specifically, the missing data detection unit 17 reads the acceleration data stored in the sensor DB 12a in units of sampling periods to detect whether the missing data item exists in the read acceleration data.

FIG. 3 is an explanatory diagram of detection of a missing data period. As illustrated in FIG. 3, the missing data detection unit 17 reads the acceleration data measured for a second from the sensor DB 12a. When the read acceleration data is less than 200 samples, the missing data detection unit 17 detects the presence of a missing data item. Note that the illustrated sampling period and number of samples are examples and the settings for the period or number can arbitrarily be changed.

The interpolation unit 18 is a processing unit that interpolates a missing acceleration data item with a Gaussian process when the missing data detection unit 17 detects the missing acceleration data item in the acceleration data. Specifically, the interpolation unit 18 performs the interpolation in consideration of the data items around the missing data period, using a Gaussian process that is random variables varying over time. Using a Gaussian process enables the modeling of the distribution in the missing data period with a high degree of reliability.

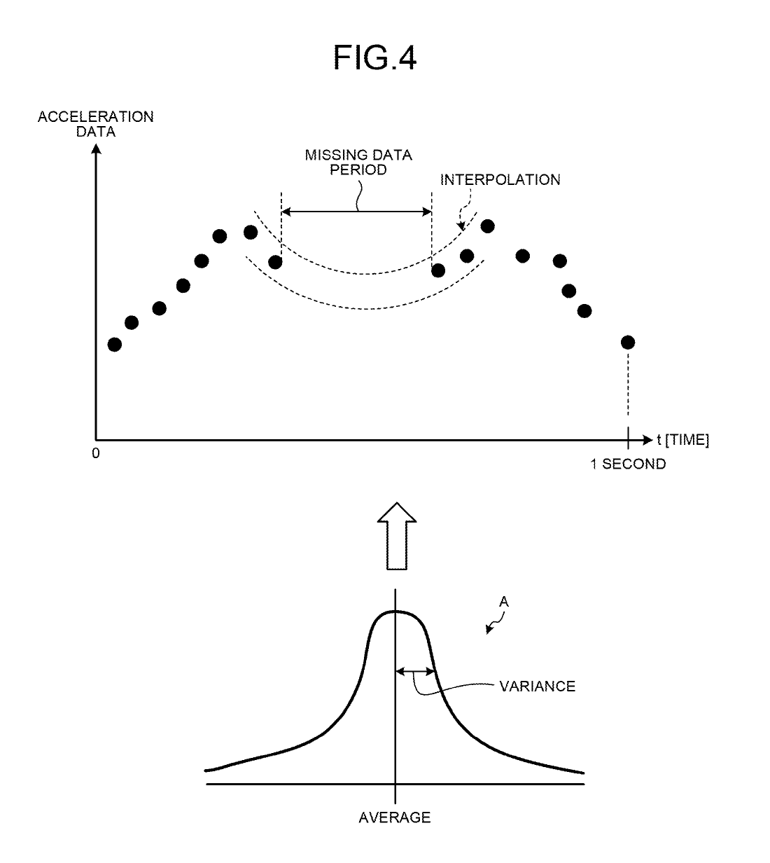

FIG. 4 is an explanatory diagram of interpolation of the missing data period. As illustrated in FIG. 4, the interpolation unit 18 derives a Gaussian distribution (A in FIG. 4) by using the average (μ) and variance (σ²) stored in the parameter DB 12b. Then, the interpolation unit 18 interpolates the acceleration data in the missing data period in accordance with the Gaussian distribution. Then, the interpolation unit 18 outputs the acceleration data in the sampling period including the interpolated missing data period to the transmission unit 19 or stores the acceleration data in the storage unit 12.

For example, the interpolation unit 18 estimates the next acceleration data item, namely, the missing acceleration data item from the acceleration data item just before the missing data item in accordance with the Gaussian distribution, and then interpolates the missing data item with the estimated data item. As described above, the interpolation unit 18 estimates the missing acceleration data item, for example, by using the acceleration data item just before the missing data item and the Gaussian distribution, and interpolates the acceleration data item in the missing data period. This enables the interpolation unit 18 to perform an interpolation with curve approximation.

The transmission unit 19 is a processing unit that transmits the acceleration data interpolated by the interpolation unit 18 to the cloud server 50. For example, the transmission unit 19 receives the acceleration data in a sampling period including the interpolated missing data period from the interpolation unit 18 and transmits the acceleration data to the cloud server 50. The transmission unit 19 can transmit the acceleration data together with the identifier of the mobile terminal 10.

Functional Configuration of Cloud Server

As illustrated in FIG. 1, the cloud server 50 includes a communication unit 51, a storage unit 52, and a control unit 55. The storage unit 52 is an example of a storage device such as a hard disk or a memory. The control unit 55 is an example of a processor such as a CPU or a Micro Processor Unit (MPU).

The communication unit 51 is a processing unit that performs communication with another device. For example, the communication unit 51 receives the interpolated acceleration data from the mobile terminal 10. The communication unit 51 transmits various types of information including the parameters to be used to interpolate the acceleration data and the activity recognition result to the mobile terminal 10.

The storage unit 52 is an example of a storage device, and stores a parameter DB 52a, a measurement result DB 52b, and a recognition result DB 52c. The storage unit 52 stores the acceleration data to be used for initial learning, namely, the training data.

The parameter DB 52a is a database that stores the parameters that the mobile terminal 10 uses for interpolation. For example, the parameter DB 52a stores an average (μ) of the acceleration data and a variance (σ²) of the acceleration data. The parameter DB 52a stores also a hyper-parameter of a kernel function and a parameter of a log-likelihood function.

Note that the parameter DB 52a gives an identifier to the mobile terminal 10 and links each parameter to the identifier and holds the parameters and identifiers. This enables the parameter DB 52a to store the parameters for each mobile terminal 10.

The measurement result DB 52b is a database that stores the acceleration data received from the mobile terminal 10. In other words, the measurement result DB 52b stores the acceleration data that is measured in a sampling period and in which the missing acceleration data in a missing data period is interpolated by the mobile terminal 10. Note that the measurement result DB 52b can also store the measurement result for each mobile terminal 10.

The recognition result DB 52c is a database that stores the result from activity recognition. For example, the recognition result DB 52c stores the time when an activity is recognized, the identifier that identifies the mobile terminal 10, the recognition result, and a group of the acceleration data items used for the recognition, or an identifier that specifies the group of the acceleration data items while linking them to each other.

The link allows for specifying what time and what the user of each mobile terminal 10 does. Meanwhile, the acceleration data items can be linked to the user, the user can be linked to the activity, the activity can be linked to the acceleration data items, and the user, the activity, and the acceleration data items can be linked to each other.

The control unit 55 is a processing unit that controls the entire cloud server 50, and includes a reception unit 56, a feature calculation unit 57, an activity recognition unit 58, and a learning unit 59. Note that the reception unit 56, the feature calculation unit 57, the activity recognition unit 58, and the learning unit 59 are examples of an electronic circuit in a processor, a process that the processor performs, or the like.

The reception unit 56 is a processing unit that receives the acceleration data from the mobile terminal 10. For example, the reception unit 56 receives a group of the interpolated acceleration data items from the mobile terminal 10, and stores the group in the measurement result DB 52b. When receiving an identifier that identifies the mobile terminal 10 together with the group of the acceleration data items, the reception unit 56 links the identifier to the group of the acceleration data, and stores the linked identifier and group in the measurement result DB 52b.

The feature calculation unit 57 is a processing unit that calculates the feature of the group of the acceleration data items received by the reception unit 56. Specifically, when receiving an instruction for activity recognition, the feature calculation unit 57 obtains the acceleration data of the user, who does the activity, from the measurement result DB 52b. Subsequently, the feature calculation unit 57 performs a common feature calculation process, such as frequency analysis, to calculate the feature from the obtained acceleration data. Then, the feature calculation unit 57 outputs the calculated feature to the activity recognition unit 58.

For example, the feature calculation unit 57 calculates the difference between the maximum value and minimum value in the acceleration data, the variance value of the acceleration data, the average value of the acceleration data, or the maximum amplitude of the acceleration data. Note that various publicly known methods can be used for the calculation of the feature. For example, the feature calculation unit 57 can determine what activity feature the received acceleration data has by comparing the distribution of the received acceleration data with the distribution linked to each type of activities.

The activity recognition unit 58 is a processing unit that specifies the activity by the user of the mobile terminal 10 in accordance with the feature calculated by the feature calculation unit 57. For example, the activity recognition unit 58 stores the information indicating the link between each type of activities and the feature, for example, in the storage unit 52. Then, the activity recognition unit 58 specifies the activity corresponding to the feature received from the feature calculation unit 57 in accordance with the information.

As described above, the activity recognition unit 58 specifies the activity from the feature of the acceleration data. After that, the activity recognition unit 58 links the specified activity to the identifier identifying the user or the identifier identifying the acceleration data, and stores the linked identifier and activity in the recognition result DB 52c. Alternatively, the activity recognition unit 58 can transmit the recognition result to the mobile terminal 10. Note that the activity recognition method described herein is merely an example, and various publicly known methods can be used for the activity recognition.

For example, the activity recognition unit 58 can use a Gaussian Mixture Model (GMM) to perform activity recognition. Specifically, the activity recognition unit 58 estimates, for each activity pattern, the weight “w”, average vector “μ”, and variance-covariance matrix “Σ” that are the parameters of the Gaussian distribution from the acceleration data for model learning. In the estimation, the activity recognition unit 58 first sets how many of Gaussian distributions the activity is modeled from.

When determining which activity pattern the acceleration data currently recognized is classified into, the activity recognition unit 58 calculates the log likelihood of the learnt Gaussian distribution and the feature of the acceleration data currently recognized in expressions (1) and (2), and classifies the acceleration data into the activity pattern at the maximum log likelihood. In the expressions, “i” is the number of the activity pattern, “j” is the number of the Gaussian distribution, “M” is the number of Gaussian distributions, “x” is the feature of the acceleration data currently recognized, “λ” is the model of the activity pattern, “d” is the number of dimensions of the feature, “w” is the weight of the Gaussian distribution, “μ” is the average vector of the Gaussian distribution, and “Σ” is the variance-covariance matrix of the Gaussian distribution.

$$\begin{matrix} {argmax}_{i} {\sum }_{j = 1}^{M} {w}_{j}^{i} log p ( x \vert {λ}_{j}^{i} ) & ( 1 ) \\ log p ( x \vert {λ}_{j}^{i} ) = - \frac{d}{2} log 2 π - \frac{1}{2} log \vert {\sum }_{j}^{i} \vert - \frac{1}{2} {( x - {μ}_{j}^{i} )}^{t} {\sum }_{j}^{{i}^{- 1}} ( x - {μ}_{j}^{i} ) & ( 2 )\end{matrix}$$

The learning unit 59 is a processing unit that learns the parameters that the mobile terminal 10 uses for interpolation. The learning unit 59 links each of the learnt parameters, for example, to the identifier identifying the mobile terminal 10 and stores the linked parameters and identifier in the parameter DB 52a.

Description about Learning Process

A learning process will be described in detail hereinafter. The learning unit 59 learns the average (μ) and the variance (σ²) by learning the hyper-parameter of the kernel function and the parameter of the log-likelihood function to be used for a Gaussian process. Specifically, the learning unit 59 puts initial values into the hyper-parameter of the kernel function and the parameter of the log-likelihood function, and assigns the acceleration data to the log-likelihood function to calculate the values. If the calculated value rises, the learning unit 59 updates each of the parameters. If the calculated value does not rise, the learning unit 59 sets the current parameters as the learnt values.

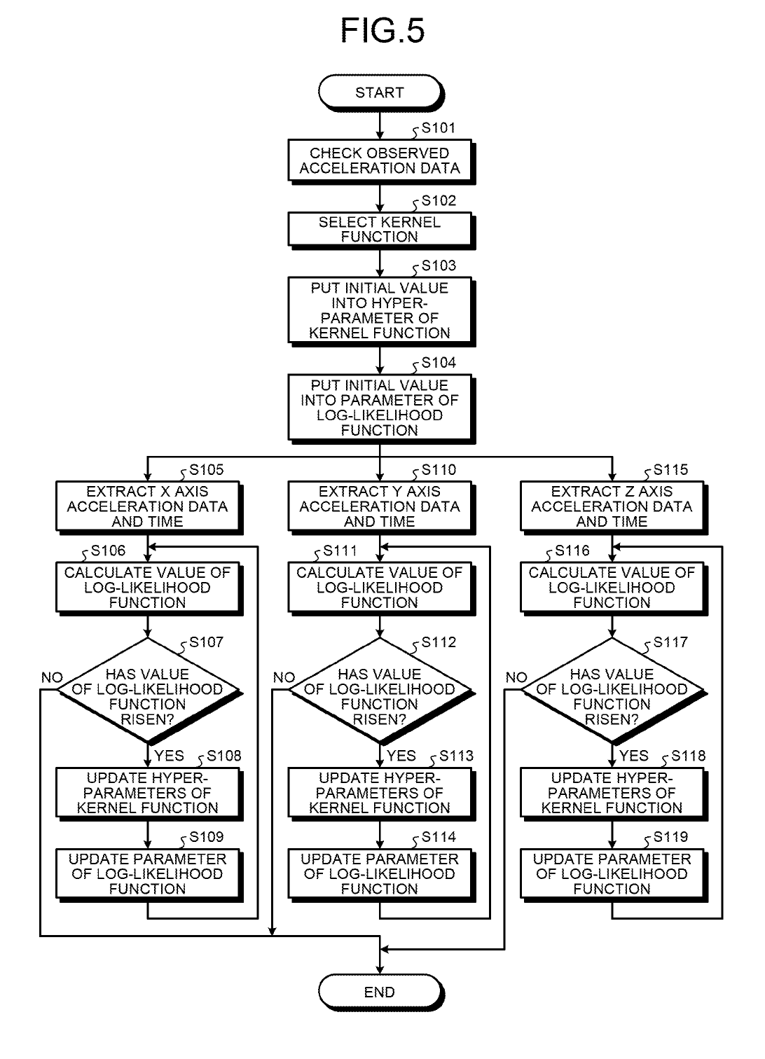

The learning process will be described in detail hereinafter with reference to FIG. 5 and each expression. FIG. 5 is a flowchart of the flow of the learning process. As illustrated in FIG. 5, once starting a learning process, the learning unit 59 checks the acceleration data (S101), and selects a kernel function appropriate to the checked acceleration data (S102).

An exemplary kernel function will be described hereinafter. An expression (3) is a Gaussian kernel. An expression (4) is an index kernel. For example, the x and x′ in the expression (3) are input values, each of which is the acceleration data item observed at an arbitrary time (frame), and indicate the acceleration data items observed at different times, respectively. The v and r are the hyper-parameters. The x and x′ in the expression (4) are identical to those in the expression (3). The x^{T} indicates the row vector that the vector of the acceleration data items x horizontally arranged (namely, the transpose of a vector). The θ₀, θ₁, θ₂, and θ₃ are the hyper-parameters.

$$\begin{matrix}k ( x , {x}^{′} ) = {v}^{2} exp ( - \frac{{( x - {x}^{′} )}^{2}}{2 {r}^{2}} ) & ( 3 ) \\ k ( x , {x}^{′} ) = {θ}_{0} exp \{ - \frac{{θ}_{1}}{2} {‖ x - {x}^{′} ‖}^{2} \} + {θ}_{2} + {θ}_{3} {x}^{T} {x}^{′} & ( 4 )\end{matrix}$$

Subsequently, the learning unit 59 puts initial values into the hyper-parameters of the kernel function (S103), and puts an initial value into the parameter of the log-likelihood function (S104). An expression (5) is an exemplary log-likelihood function. The y is the value to be estimated, the X is the measured acceleration data item, the θ is the average value or the variance value, and the σ is the parameter in the expression (5).

$$log p ( y \vert X , θ ) = - \frac{1}{2} {{y}^{T} ( K + {σ}^{2} I )}^{- 1} y - \frac{1}{2} log \vert K + {σ}^{2} I \vert - \frac{n}{2} log 2 π . \qquad ( 5 )$$

After that, the learning unit 59 extracts the X axis acceleration data item and the time from the storage unit 52 (S105), and assigns the extracted data item and time to the log-likelihood function to calculate the value (S106). When the value of the log-likelihood function rises from the value previously calculated (S107: Yes), the learning unit 59 updates the hyper-parameters of the kernel function in a gradient method (S108), and updates the parameter of the log-likelihood function in a gradient method (S109). After that, the learning unit 59 repeats the process in S106 and subsequent steps. Note that the learning unit 59 terminates the learning when the value of the log-likelihood function does not rise from the value previously calculated (S107: No).

Similarly, the learning unit 59 extracts the Y axis acceleration data item and the time from the storage unit 52 (S110), and assigns the extracted data item and time to the log-likelihood function to calculate the value (S111). When the value of the log-likelihood function rises from the value previously calculated (S112: Yes), the learning unit 59 updates the hyper-parameters of the kernel function in a gradient method (S113), and updates the parameter of the log-likelihood function in a gradient method (S114). After that, the learning unit 59 repeats the process in S111 and subsequent steps. Note that the learning unit 59 terminates the learning when the value of the log-likelihood function does not rise from the value previously calculated (S112: No).

Similarly, the learning unit 59 extracts the Z axis acceleration data item and the time from the storage unit 52 (S115), and assigns the extracted data item and time to the log-likelihood function to calculate the value (S116). When the value of the log-likelihood function rises from the value previously calculated (S117: Yes), the learning unit 59 updates the hyper-parameters of the kernel function in a gradient method (S118), and updates the parameter of the log-likelihood function in a gradient method (S119). After that, the learning unit 59 repeats the process in S116 and subsequent steps. Note that the learning unit 59 terminates the learning when the value of the log-likelihood function does not rise from the value previously calculated (S117: No).

Flow of Interpolation Process

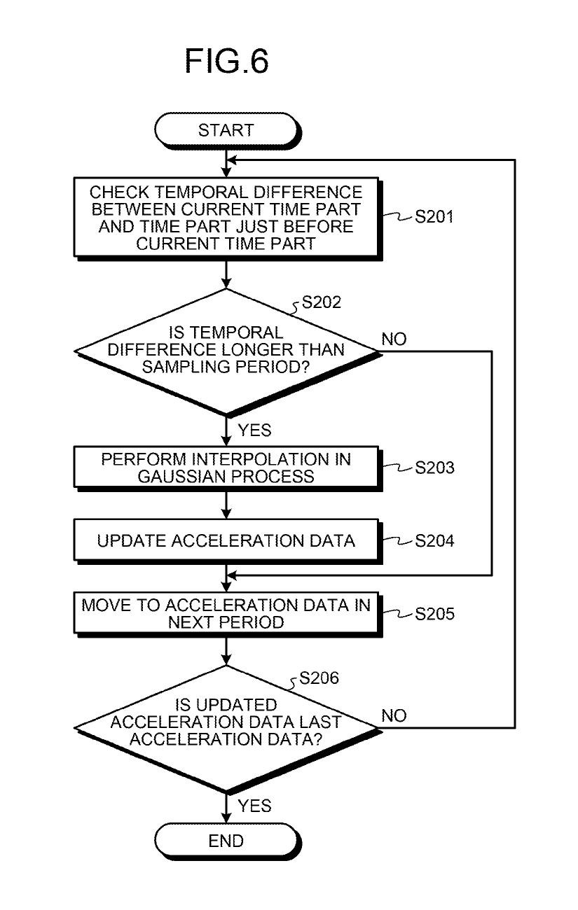

An interpolation process will be described next. FIG. 6 is a flowchart of the flow of an interpolation process. Note that the detection of the missing data described with reference to FIG. 6 is an example.

As illustrated in FIG. 6, once starting an interpolation process, the interpolation unit 18 checks the temporal difference between the current period and the period just before the current period (S201), and determines whether the temporal difference is longer than a sampling period (S202).

When the temporal difference is longer than the sampling period (S202: Yes), the interpolation unit 18 performs interpolation in a Gaussian process (S203), and updates the acceleration data in the sampling period with the interpolated data (S204).

After that, the interpolation unit 18 determines the acceleration data in the next period as the acceleration data to be processed (S205), and terminates the process when the updated data is the last data (S206: Yes). On the other hand, when the updated data is not the last data and unprocessed data remains (S206: No), the interpolation unit 18 processes the acceleration data in the next period in the process in S201 and subsequent steps.

When the period is shorter than the sampling period in S202 (S202: No), the interpolation unit 18 performs the process in S205 and subsequent steps.

The interpolation process will be described in detail hereinafter. When output variables y relative to the input variables x follow a Gaussian process, the vector y of all of the output variables can generally be expressed as the following multidimensional Gaussian distribution (expression (6)).

p(y)=N(0,K+β⁻¹I) (6)

In the expression, the K is a gram matrix of which elements are K_{i, j}=k(xᵢ, xⱼ), and the k(xᵢ, xⱼ) is a kernel function indicating the correlation between the two variables. The β is the hyper-parameter indicating the degree of accuracy of the noise of the output variable y.

The interpolation unit 18 separately interpolates the acceleration data items in the X, Y, and Z axes in an interpolation process with the Gaussian process. When the learning data that is the acceleration data observed at the sampling rate previously designated (including a missing data item) is y, the time of the frame when the y is observed is x, the time of the frame to be interpolated is x_{*}, and the acceleration data in the frame to be interpolated is y_{*}, the simultaneous distribution of the acceleration data items y of the set of learning data items and the acceleration data items y_{*} in the frame to be interpolated is expressed as an expression (7).

$$[ \begin{matrix}y \\ {y}_{*}\end{matrix} ] \sim N ( 0 , [ \begin{matrix}k ( x , x ) + {β}^{- 1} I & k ( x , {x}_{*} ) \\ k ( {x}_{*} , x ) & k ( {x}_{*} , {x}_{*} )\end{matrix} ] ) \qquad ( 7 )$$

The estimated distribution of the acceleration data items y_{*} in the frame to be interpolated is expressed as the Gaussian distribution with the average μ_{*} and covariance σ_{*} as expressed in expressions (8) and (9).

μ_{*}=k(x_{*},x)[k(x,x)+β⁻¹I]⁻¹y (8)

σ_{*}²=k(x_{*},x_{*})+β⁻¹−k(x_{*},x)[k(x,x)+β⁻¹I]⁻¹k(x,x_{*}) (9)

The interpolation unit 18 interpolates the acceleration data item in the frame to be interpolated in accordance with the estimated distribution, using the acceleration data items in the frame just before the frame to be interpolated.

Effect

By interpolating the data with a Gaussian process with high reliability as described above, the activity recognition system can use a universal law that the events of nature basically follow the Gaussian distribution. Differently from linear interpolation, an interpolation with a Gaussian process can model the distribution in a missing data period with a high degree of reliability in consideration of the data items around the missing data period. This can increase the recognition rate of the activity recognition device without adding a process for changing the weight due to the presence or absence of interpolation as the examples of the past.

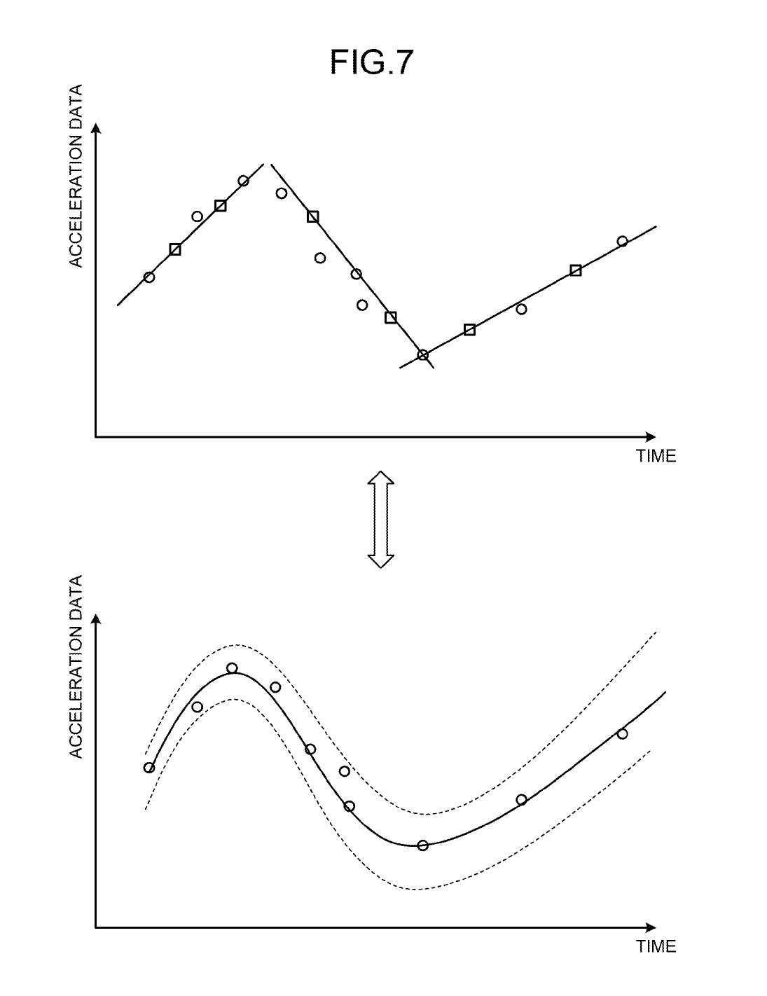

FIG. 7 is an explanatory diagram of the comparison of interpolation. As illustrated in the upper part of FIG. 7, an acceleration data item between the measured frames is linearly approximated and interpolated merely as an average value in a linear interpolation. On the other hand, in a Gaussian process, the estimated distribution is learnt from the measured acceleration data items. This learning allows for curve approximation. Thus, the time of the frame to be interpolated can be set and the acceleration data in the time can be interpolated. The reliability of the interpolated value can also be found from the variance of the estimated distribution. Note that the symbols ∘ in FIG. 7 indicate the measured acceleration data items, and the symbols □ indicate the interpolated acceleration data items.

### [b] Second Embodiment

In the first embodiment, the cloud server 50 of the activity recognition system learns the parameters to be used for interpolation. However, learning also the training data to be used for the learning of the parameters can improve the accuracy of the parameters.

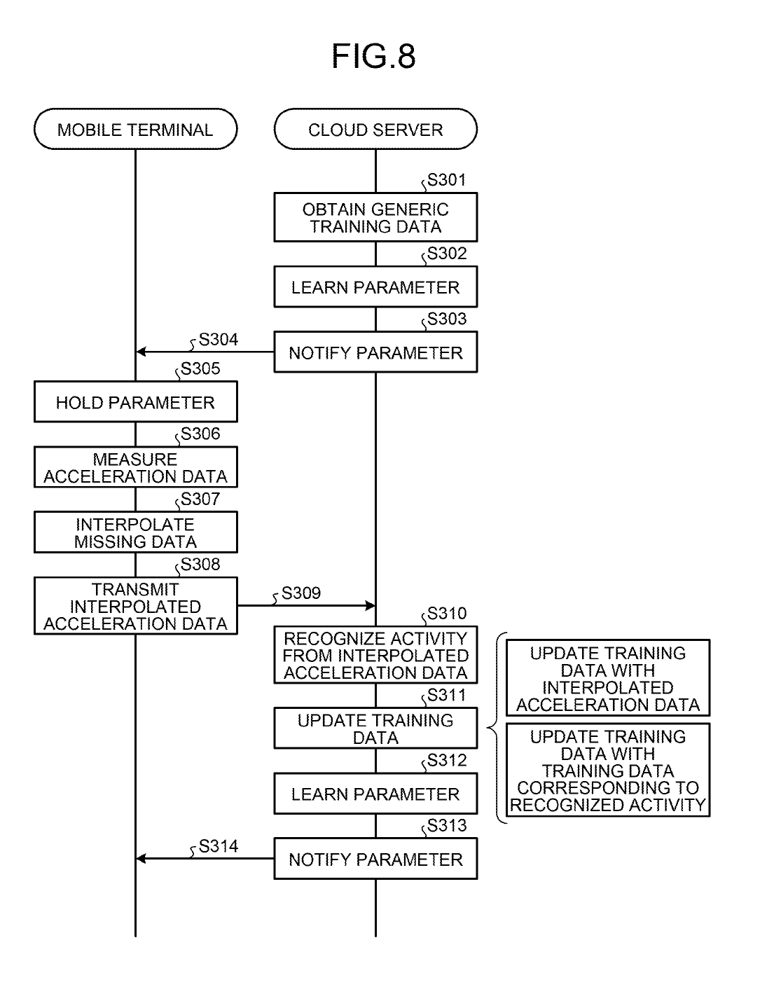

FIG. 8 is a sequence diagram of the flow of a learning process according to the second embodiment. As illustrated in FIG. 8, the learning unit 59 in the cloud server 50 obtains generic training data (acceleration data) previously prepared (S301), learns the parameters with the training data (S302), and notifies the learnt parameters to the mobile terminal 10 (S303 and S304).

The measurement unit 16 in the mobile terminal 10 holds the received parameters by storing the parameters in the parameter DB 12b (S305). After that, the measurement unit 16 measures the acceleration data (S306), and the interpolation unit 18 interpolates the detected missing data by using the parameters (S307). Then, the transmission unit 19 transmits the interpolated acceleration data to the cloud server 50 (S308 and S309).

Subsequently, the feature calculation unit 57 and activity recognition unit 58 in the cloud server 50 recognize the activity of the user by performing activity recognition using the received interpolated acceleration data (S310). Subsequently, the learning unit 59 updates the training data to be learnt with the interpolated acceleration data, or with the training data corresponding to the activity recognized by the activity recognition (S311).

Then, the learning unit 59 learns the parameters with the updated training data (S312), and notifies the learnt parameter to the mobile terminal 10 (S313 and S314).

The training data can be learnt from the activity recognition result or the interpolated acceleration data in the manner described above. Thus, the parameters can also be learnt in accordance with the activity of the user or the acceleration data.

### [c] Third Embodiment

The cloud server 50 of the activity recognition system illustrated in FIG. 1 can improve the accuracy of the parameters by learning the parameters for each activity to be recognized.

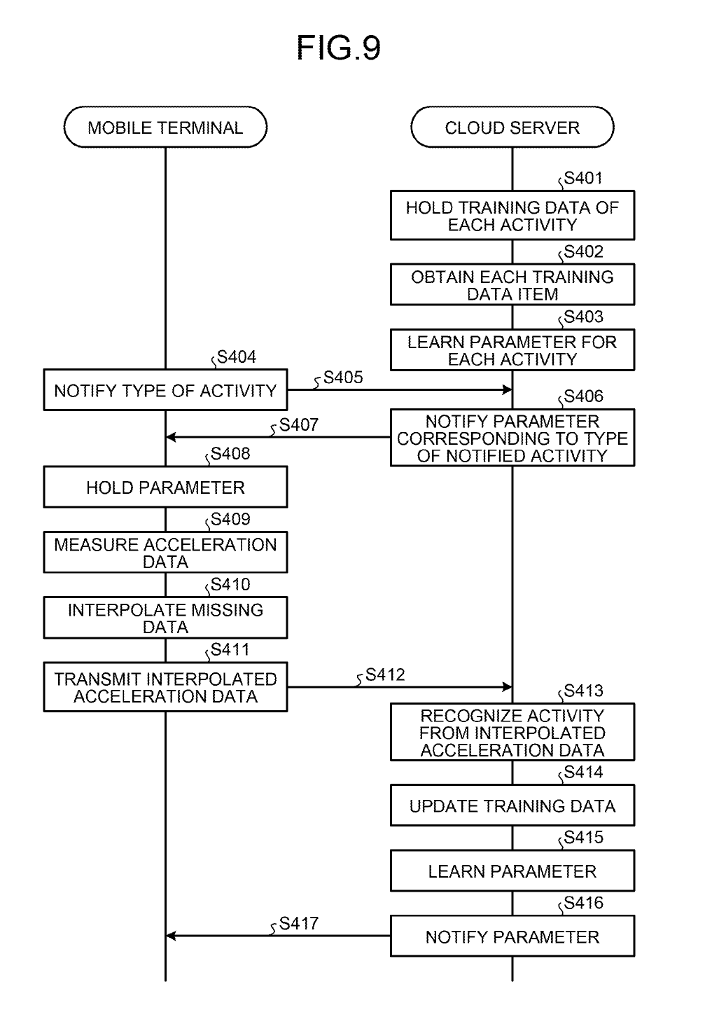

FIG. 9 is a sequence diagram of the flow of a learning process according to the third embodiment. As illustrated in FIG. 9, the learning unit 59 of the cloud server 50 holds the prepared training data (acceleration data) of each activity (S401), and obtains each training data item (S402). For example, the learning unit 59 reads the training data, for example, from the storage unit 52. The learning unit 59 learns the parameters for each activity, using the training data of each activity (S403).

Then, the mobile terminal 10 notifies the type of the activity designated, for example, by the user and to be recognized to the cloud server 50 (S404 and S405). The learning unit 59 of the cloud server 50 that receives the notification notifies the parameters corresponding to the notified type of activity to the mobile terminal 10 (S406 and S407).

The measurement unit 16 of the mobile terminal 10 holds the received parameters by storing the parameters in the parameter DB 12b (S408). Subsequently, the measurement unit 16 measures the acceleration data (S409), and the interpolation unit 18 interpolates the detected missing data with the parameters (S410). Then, the transmission unit 19 transmits the interpolated acceleration data to the cloud server 50 (S411 and S412).

Subsequently, the feature calculation unit 57 and activity recognition unit 58 in the cloud server 50 recognize the activity of the user by performing activity recognition using the received interpolated acceleration data (S413). Subsequently, the learning unit 59 updates the training data to be learnt, for example, with the interpolated acceleration data (S414).

Then, the learning unit 59 learns the parameters with the updated training data (S415), and notifies the learnt parameters to the mobile terminal 10 (S416 and S417).

The training data and the parameters can be learnt per activity in the manner described above. This can improve the accuracy of the parameter in comparison with the learning with generic training data.

### [d] Fourth Embodiment

The first to third embodiments of the mobile terminal, sensor value interpolation method, computer-readable recording medium, activity recognition device, and activity recognition system have been described above. However, the mobile terminal, sensor value interpolation method, computer-readable recording medium, activity recognition device, and activity recognition system can be implemented with various different modes in addition to the embodiments described above.

Learning Per Individual

In the third embodiment, the parameters are learnt per activity. However, the learning is not limited to the embodiment. For example, the training data is prepared for each individual, and the parameters can be learnt per individual. Specifically, the cloud server 50 prepares the training data for each user ID, and receives a user ID from the mobile terminal 10. Then, the cloud server 50 can learn the parameters using the training data corresponding to the received user ID and notify the learnt parameters to the mobile terminal 10. Alternatively, the cloud server 50 can learn the parameters per activity of each user by linking the user ID, the type of the activity, and the training data to each other and managing them.

Division and Combination of Functions

In the first embodiment, the mobile terminal 10 interpolates the acceleration data and the cloud server 50 performs the activity recognition. The interpolation and activity recognition are not limited to the embodiment. For example, the mobile terminal 10 can perform the measurement and interpolation of the acceleration data, activity recognition, and learning, and then transmit the activity recognition result to the cloud server 50. Alternatively, the mobile terminal 10 can measure the acceleration data and transmit the measured acceleration data to the cloud server 50, and the cloud server 50 can interpolate the acceleration data and perform the activity recognition. As described above, the processes can arbitrarily be divided and combined.

System

Each configuration of the illustrated components is not always the physical structure as illustrated. In other words, the configuration can be divided or combined in an arbitrary unit. Furthermore, all or an arbitrary part of processing functions performed in each component can be implemented with a CPU and a program analyzed and executed with the CPU, or can be implemented as wired-logic hardware.

Among the processes described in the present embodiments, all or some of the processes automatically performed can manually be performed while all or some of the processes manually performed can automatically be performed in a publicly known method. Additionally, the procedures of the processes, the procedures of the controls, specific names, the information including various types of data or parameters described herein or illustrated in the drawings can arbitrarily be changed unless otherwise noted.

Hardware Configuration

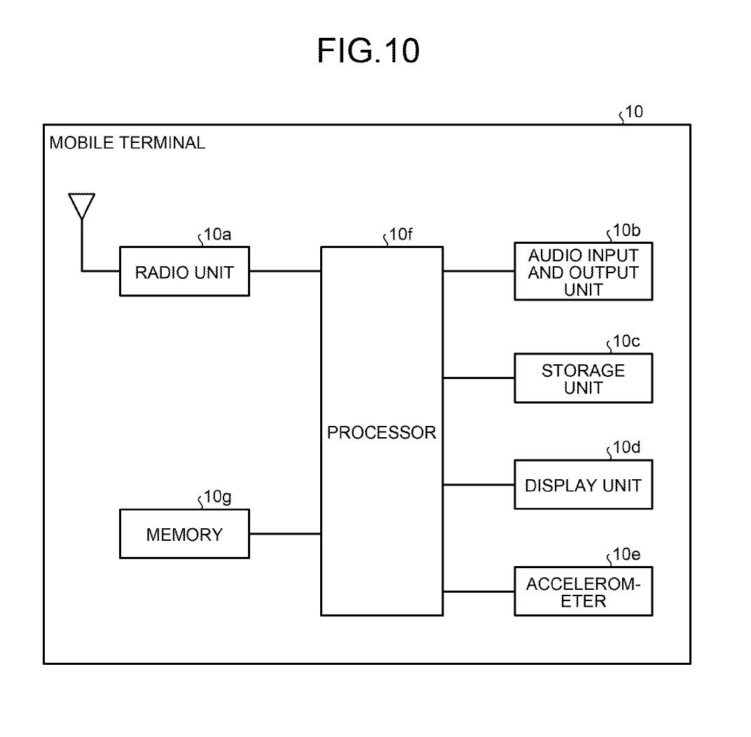

FIG. 10 is an explanatory diagram of an exemplary hardware configuration. As illustrated in FIG. 10, the mobile terminal 10 includes a radio unit 10a, an audio input and output unit 10b, a storage unit 10c, a display unit 10d, an accelerometer 10e, a processor 10f, and a memory 10g. Note that the hardware described herein is an example, and can include another hardware, for example, another sensor.

An exemplary hardware configuration of the mobile terminal 10 will be described herein as an example. Note that the cloud server 50 can be a common physical server including a processor and a memory, or can be implemented with a virtual machine.

The radio unit 10a performs, for example, transmission and reception or sending and incoming of an email by performing wireless communication via an antenna. The audio input and output unit 10b outputs various sounds from the loudspeaker, and collects various sounds from the microphone.

The storage unit 10c is a storage device that stores various types of information, and is, for example, a hard disk or a memory. For example, the storage unit 10c stores various programs that the processor 10f executes or various types of data. The display unit 10d is a display unit that displays various types of information, and is, for example, a touch panel display.

The processor 10f is a processing unit that controls the entire mobile terminal 10 and performs various applications, and is, for example, a CPU. For example, the processor 10f operates the process for executing each function described with reference to, for example, FIG. 1 by reading a program for performing a similar process to the process by each processing unit illustrated, for example, in FIG. 1, from the storage unit 10c or the like and developing the program, into the memory 10g or the like.

In other words, the process executes a similar function to the function of each processing unit included in the mobile terminal 10. Specifically, the processor 10f reads a program having a similar function to the function of the measurement unit 16, the missing data detection unit 17, the interpolation unit 18, or the transmission unit 19, for example, from the storage unit 10c. Then, the processor 10f executes the process for performing the similar process to the process by the measurement unit 16, the missing data detection unit 17, the interpolation unit 18, or the transmission unit 19.

As described above, the mobile terminal 10 operates as an information processing apparatus that performs a sensor value interpolation method by reading and executing a program. Note that other programs described in the embodiments are not limited to the program executed by the mobile terminal 10. The mobile terminal, sensor value interpolation method, computer-readable recording medium, activity recognition device, and activity recognition system are also applicable in a similar manner, for example, when another computer or server executes the programs, or the cooperation of the computer and server executes the programs.

According to the embodiment, the accuracy of activity recognition can be improved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile terminal comprising:
a processor that executes a process including:
measuring sensor values in a predetermined period;
detecting whether a missing sensor value exists in the predetermined period; and
interpolating the missing sensor value with a Gaussian process when the missing sensor value exists.

2. The mobile terminal according to claim 1, wherein
the interpolating includes selecting a kernel function appropriate to a type of an activity recognized by activity recognition with the sensor values, and interpolating the missing sensor value with the Gaussian process in accordance with the selected kernel function.

3. The mobile terminal according to claim 1, wherein the process further comprises:
deriving a distribution function from a measured value measured in advance with the Gaussian process, and
calculating a parameter of the measured value with the derived distribution function, wherein
the interpolating includes interpolating the missing sensor value with Gaussian distribution in the Gaussian process in accordance with the parameter calculated at the calculating.

4. The mobile terminal according to claim 3, wherein
the calculating includes deriving a distribution function from the measured value linked to a user of the mobile terminal, and calculating the parameter with the derived distribution function, and
the interpolating includes interpolating the missing sensor value with the Gaussian distribution in accordance with the parameter linked to the user.

5. The mobile terminal according to claim 3, wherein
the calculating includes deriving a distribution function appropriate to each activity to be recognized in activity recognition performed with the sensor values from each measured value linked to each of the activities, and calculating each of parameters of each of the measured values linked to each of the activities from the derived distribution function, and
the interpolating includes selecting the parameter linked to the activity to be recognized among the each of parameters, and interpolating the missing sensor value with the Gaussian distribution in accordance with the selected parameter.

6. A computer-readable recording medium having stored therein a program that causes a computer to execute a process comprising:
measuring sensor values in a predetermined period;
detecting whether a missing sensor value exists in the predetermined period; and
interpolating the missing sensor value with a Gaussian process when the missing sensor value exists.

7. An activity recognition device comprising:
a processor that executes a process including:
obtaining sensor values measured in a predetermined period by a mobile terminal;
detecting whether a missing sensor value exists in the predetermined period;
interpolating the missing sensor value with a Gaussian process when the missing sensor value exists; and
recognizing an activity of a user of the mobile terminal with the sensor values including the interpolated sensor value in the predetermined period.
